(19) United States
(12) Patent Application Publication
(10) Pub. No.: US 2008/0271920 A1
(43) Pub. Date: Nov. 6, 2008

(54) System for Supplying Electrical Energy to Assimilation Lamps in a Glasshouse, Glasshouse Lighting Power Current Cable for Use in a Glasshouse

(75) Inventor: Teunis Cornelis van den Dool, Monster (NL)

Correspondence Address: TROUTMAN SANDERS LLP, 600 PEACHTREE STREET , NE, ATLANTA, GA, 30308, US

(73) Assignee: HORTILUX SCHREDER B.V., MONSTER (NL)

(21) Appl. No.: 12/092,041

(22) PCT Filed: Oct. 26, 2006
(86) PCT No.: PCT/NL2006/000541

§ 371 Date: Jul. 11, 2008

(30) Foreign Application Priority Data
Oct. 31, 2005 (NL) 1030306

(51) Int. Cl. H02G 3/00

(52) U.S. Cl. 174/70 R

(57) ABSTRACT

The invention relates to a glasshouse lighting power current cable for supplying electrical energy to assimilation lamps in a glasshouse. The glasshouse lighting power current cable according to the invention has at least three electrically insulated through conductors embedded in the cable for the transmission of three-phase current, the cable being provided with a plurality of connecting points distributed along its length, at which connecting points the conductors are exposed. The connecting points can each be provided with a connector, which connector can be connected to each of the conductors, the connecting points in each case being situated at a fixed, predetermined distance from each other.

The invention relates to a system for glasshouse lighting, a glasshouse lighting power supply cable, and a method for fitting a system for glasshouse lighting in a glasshouse.

NL 7613233 discloses a lighting installation for propagation glasshouses. The known lighting installation comprises several glasshouse lighting fixtures, each suspended by means of a bearing frame from a profiled section which extends horizontally through the glasshouse. The individual glasshouse lighting fixtures each comprise a connecting unit for electrically connecting the glasshouse lighting fixture to an external power source.

The first glasshouse lighting fixture of a group of glasshouse lighting fixtures belonging together is connected by way of the power input of its connecting unit to an external power source, for example the lighting mains. A power cable with a plug on both of its ends then connects the power output of the first glasshouse lighting fixture to the power input of the following glasshouse lighting fixture of the group.

A separate power current cable is needed for each group of glasshouse lighting fixtures in order to supply three-phase current for operating the assimilation lamps. This means that large, heavy cable trees are needed for the power supply, which cable trees also often have to be made specifically for the layout of the glasshouse.

The object of the invention is to provide an improved system for supplying electrical energy to assimilation lamps in a glasshouse, an improved system for connecting assimilation lighting in a glasshouse, and an improved glasshouse lighting power current cable for supplying electrical energy to assimilation lamps in a glasshouse.

The invention achieves the object with a system for supplying electrical energy to assimilation lamps in a glasshouse according to claim 1, with the method for connecting an assimilation lighting system in a glasshouse according to claim 7, and with a glasshouse lighting power current cable for supplying electrical energy to assimilation lamps in a glasshouse according to claim 9.

The invention relates to a system for supplying electrical energy to assimilation lamps in a glasshouse according to claim 1.

In this system use is made of a glasshouse lighting power current cable such as that described further on in this application. After fitting, said glasshouse lighting power current cable preferably lies in a rail which has a U-shaped cross section. The open side of the rail preferably faces upwards. As an alternative, the open side can also face sideways. The glasshouse lighting power current cable preferably rests on the inside of the rail, so that the glasshouse lighting power current cable does not sag under the influence of gravity.

In an advantageous embodiment the connectors for the glasshouse lighting power current cable can be snapped securely onto the open side of the rail. The cable is positioned in the rail in this way.

In a further advantageous embodiment the distribution box is connected to a feeder cable. Said feeder cable then provides an electrical connection between the glasshouse lighting power current cable and an assimilation lamp. Said feeder cable can be in the form of a separate intermediate cable or can be connected directly to the fixture.

Provision is made for a phase-determining means to be present in the distribution box or in a further connector fixed on the feeder cable. Such a further connector is then situated between the distribution box and the fixture. This phase-determining means can be used to determine the phase for operating the assimilation lamp in the glasshouse lighting fixture which is fed via the distribution box and the feeder cable. By choosing the phase for each individual fixture it is ensured that a uniform phase load on the electrical system of the glasshouse can be obtained. The distribution boxes or further connectors with the phase-determining means can easily be coded so that during installation it is easy to see the sequence in which the fixtures must be connected. The phase-determining means can have a fixed or variable phase setting.

Since only the electrical supply of a single assimilation lamp needs to run through the feeder cable, the feeder cable can be considerably thinner and more flexible than the glasshouse lighting power supply cable. In many known systems for supplying electrical energy to assimilation lamps in a glasshouse the assimilation lamps are connected directly to the glasshouse lighting power supply cable. A major disadvantage of this is that the stiff glasshouse lighting power current cable is difficult to deform, so that the position of the assimilation lamp relative to the crop to be provided with lighting is influenced by the stiffness of the glasshouse lighting power supply cable. By now using a more flexible cable between the glasshouse lighting power current cable and the assimilation lamp, it is ensured that this influence on the position of the assimilation lamp relative to the crop to be provided with lighting is eliminated.

The invention also relates to a glasshouse lighting power current cable which is suitable for use in the system described above.

In a basic embodiment the suitable glasshouse lighting power current cable has at least three electrically insulated through conductors embedded in the cable for the transmission of three-phase current. In this embodiment the cable is provided with a plurality of connecting points, distributed along its length, at which the conductors are exposed, each of which connecting points is provided with a connector, which connector can be connected to each of the conductors, the connecting points in each case being at a fixed predetermined distance from each other. It is also possible for only the outer sheath of the cable to be removed at the position of the connecting point, and for the inner sheath of the individual conductors to be pierced locally at the position of the connecting point.

A major advantage of such a glasshouse lighting power current cable is that it can be manufactured at least partially in a factory prior to the addition and placing of the cable in a glasshouse. The cable can be taken into the glasshouse on a roll and can then be fitted from the roll in the glasshouse. This considerably simplifies the installation of a lighting system in a glasshouse. Owing to the fact that a plurality of connecting points have been provided on a single cable, the number of cables needed for supplying electrical energy to assimilation lamps in a glasshouse is limited. In addition, it is no longer necessary to loop through the connection in the fixtures or, for example, in a branch box. This means that the system for supplying electrical energy to assimilation lamps in a glasshouse can be kept light and simple. The installation in its entirety is also considerably easier than that of known systems.

The glasshouse lighting power current cable is preferably produced in its entirety in a factory, so that the installation work in the glasshouse is kept to a minimum.

A further advantage of a glasshouse lighting power current cable which can be produced in its entirety in advance in a factory is that each connecting point can easily be tested before the fitting. This means that the fitting of the glasshouse lighting power current cable in the glasshouse can be achieved exclusively with fully approved glasshouse lighting power supply cables. This again simplifies and speeds up the installation.

The connecting points are preferably provided with a distribution box. Said distribution box should preferably be connected to a connector which is to be connected to the connecting point. The distribution box preferably ensures that there is electrical insulation of the exposed parts of the conductors relative to each other.

The cable is preferably electromagnetically shielded in its entirety. In addition, a cable sheath is preferably present for further electrical insulation.

Using connectors which provide an electrical connection to the conductors by means of clamping creates a system which is simple to install.

Laying the conductors in one plane next to each other at the position of the connecting points means that a simple electrical connection to a connector can be made. The distribution box can therefore be a simple shape.

Assimilation lighting in a glasshouse requires high power outputs. There are often many hundreds of lighting fixtures in a horticultural glasshouse, each with a minimum power output of 400 watts, while the usual power outputs lie between 600 watts and 1000 watts per lamp. For this reason it is advantageous if the conductors of the cable together can conduct at least 10 kW of power.

For safe operation of the assimilation lighting it is desirable for the glasshouse lighting power current cable to comprise an earth wire in addition to the three conductors for the three-phase current. Of course, the earth wire also has its electrical insulation removed from it at the position of the connecting point.

An embodiment of the glasshouse lighting power current cable is envisaged in which the cable comprises several strands each with at least three conductors. Each strand is intended for conducting three-phase current. In this way an even higher power output can be fed through the cable. In this embodiment the distribution boxes are always connected to the conductors of one strand.

In this embodiment also, provision is made for an earth wire to be added to the three conductors for conducting the three-phase current. In that case each strand therefore has four conductors: the earth wire and the three conductors for the three-phase current.

In an advantageous embodiment the glasshouse lighting power current cable is in the form of a flat cable with a hard core. The hard core makes the cable more stable and cheaper. In addition, a flat cable with hard core can withstand a greater tensile force. This is advantageous particularly during the fitting of the system in a glasshouse when long ends of cable have to be pulled through the structure of the glasshouse. The conductors are preferably of a solid type in order to obtain greater tensile strength. Apart from that, round cables can also be provided with solid conductors.

The design of the cable as a flat cable furthermore has the advantage that the mutual position of the conductors is fixed and the connecting points can easily be provided mechanically.

In an advantageous embodiment the connecting point is accommodated in a distribution box which is provided with a slanting face. Said slanting face makes it easier to pull the glasshouse lighting power current cable through a glasshouse during the fitting of the glasshouse lighting system. Through the slanting face, it is easier for the distribution box of the connecting point to pass obstacles that the distribution box encounters in its path during the pulling of the cable.

The invention also relates to a method for fitting a system according to the invention in a glasshouse, as described in claim 7. As already said, the system for supplying electrical energy according to the invention makes it easier to install an assimilation lighting system in a glasshouse.

The invention will be explained below with reference to a drawing, in which an exemplary embodiment is shown in a non-limiting manner.

The drawing shows in:

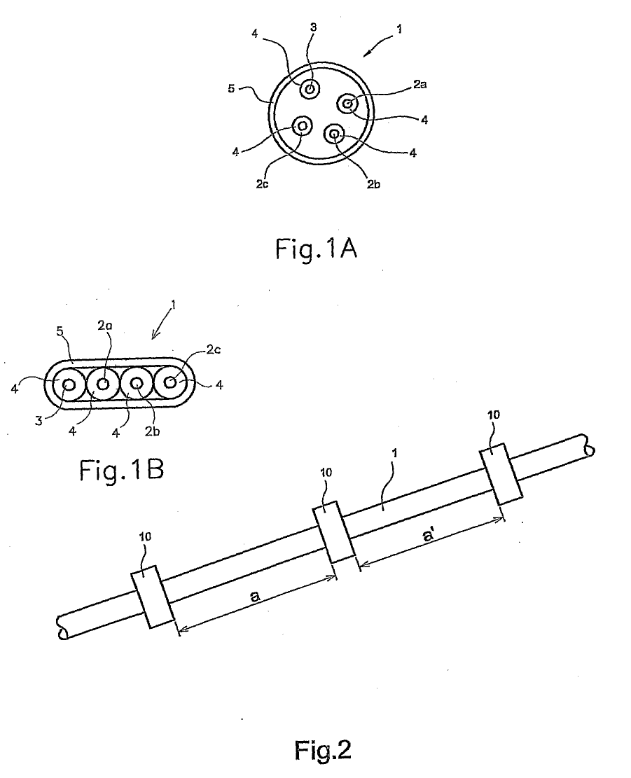

FIGS. 1A and 1B—a cross section of two possible embodiments of a glasshouse lighting power current cable according to the invention,

FIG. 2—a plan view of a part of a glasshouse lighting power current cable according to the invention,

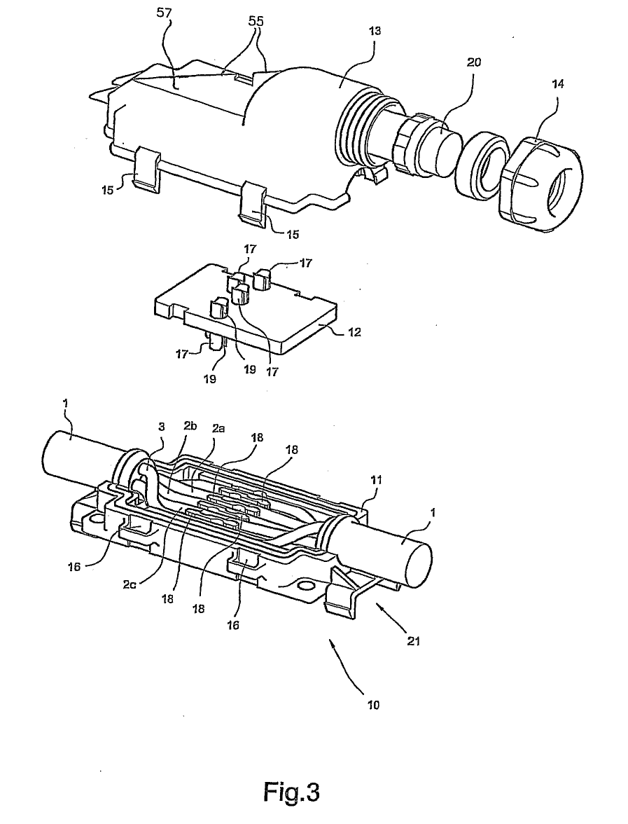

FIG. 3—a cut-away illustration of a connecting point and a connector,

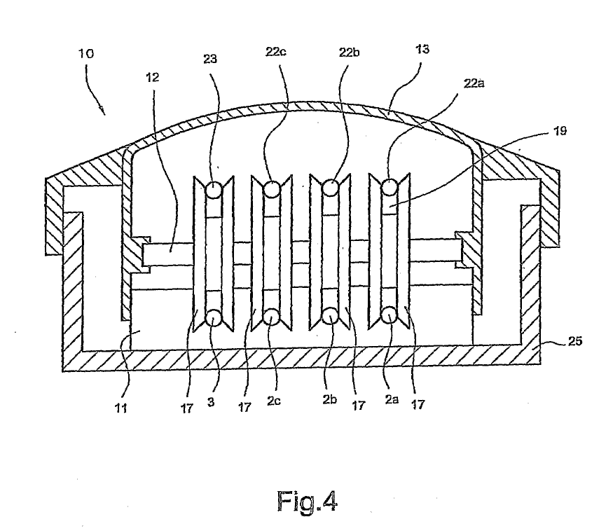

FIG. 4—a cross section of a connecting point with a connector fitted on it,

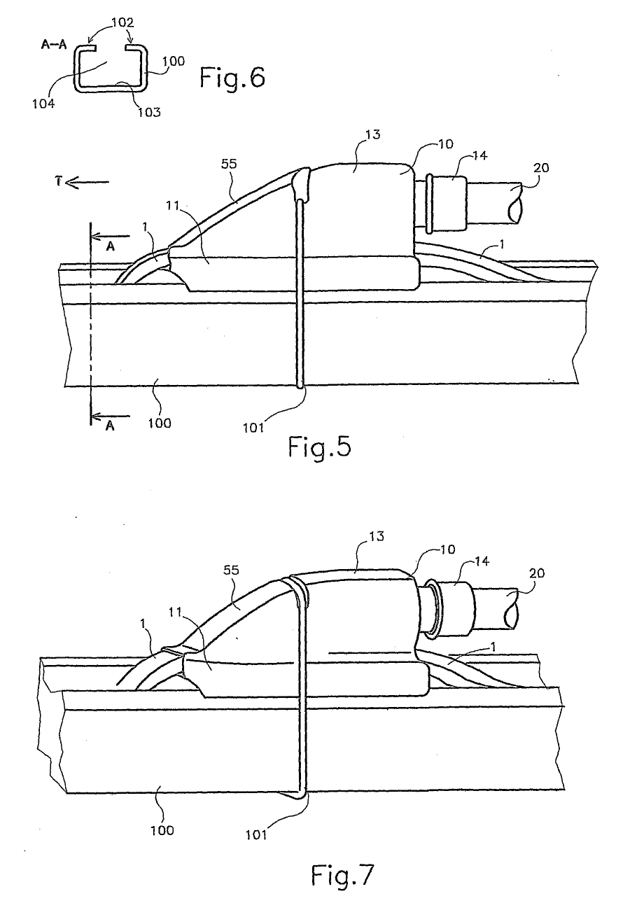

FIG. 5—an alternative embodiment of the system for supplying electrical energy to assimilation lamps in a glasshouse according to the invention, in side view,

FIG. 6—a section of the rail according to FIG. 5,

FIG. 7—the exemplary embodiment according to FIG. 5, in perspective.

FIG. 1 shows a cross section of a glasshouse lighting power current cable 1 according to the invention. Three conductors 2a-2c lie embedded in the cable 1. The conductors 2a-2c are each surrounded by a layer 4 which electrically insulates the conductor concerned. The three conductors 2a-2c together are designed to conduct three-phase current. An earth wire 3 is also present in the cable 1. The earth wire 3 is also provided with an insulating layer 4. The cable 1 comprises a plurality of connecting points. At the position of said connecting points the conductors 2a-2c and the earth wire 3 are exposed, i.e. their electrical insulating layer 4 has been removed.

A variant in which the conductors 2a-2c and/or the earth wire 3 have not had their insulating layer 4 removed is also envisaged. In this variant the insulating layer 4 is cut through or cut into locally by a connecting element in the distribution box, so that an electrical connection with the feeder cable can be made.

The cable 1 further comprises a sheath 5, which provides electromagnetic shielding and preferably also further electrical insulation.

FIG. 1A shows a variant in which the cable has a round cross section; in the example of FIG. 1B the cable is a flat cable. The cable used preferably has a hard core, preferably with solid conductors.

FIG. 2 shows a plan view of a part of the cable 1 according to the invention. Connecting points are provided at fixed, predetermined points distributed along the length of the cable 1, each connecting point being provided with a distribution box 10. The distribution boxes 10 are situated at distances a, a′ from each other. The distances a and a′ can be the same, but that is not essential. The connecting points and distribution boxes 10 are preferably already fitted at the time of production of the cable 1, and not left for fitting until the time of installation in the glasshouse.

FIG. 3 shows a cut-away view of a distribution box 10.

The conductors 2a-2c for conducting three-phase current and the earth wire 3 are stripped out of the sheath 5 of the cable 1 at the position of the connecting point and have their electrical insulation removed. The distribution box 10 comprises a base part 11, in which the conductors 2a-2c and the earth wire 3 are laid beside each other in one plane. The conductors 2a-2c and the earth wire 3 are held in place by spacers 18. Said spacers 18 also ensure that the conductors 2a-2c and the earth wire 3 are at an adequate distance from each other. Since the base part 11 and the spacers 18 are made of an electrically insulating material, base part 11 and spacers 18 ensure that the exposed parts of the conductors 2a-2c and of the earth wire 3 are electrically insulated relative to each other.

If no feeder cable 20 is connected to the connecting point, the base part 11 is preferably covered by a covering element (not shown). The covering element ensures that undesirable contact with the conductors 2a-2c and/or the earth wire 3 is prevented.

On account of the humid environment in a horticultural glasshouse, the assembly of base part 11 and covering element when assembled preferably meet the standards of protection class IP 67. This also ensures that no insects or vermin can settle in the connecting point 10.

The connecting points and the distribution boxes 10 are preferably already fitted in the factory where the cable 1 is made, and not left for fitting until the time of installation in the glasshouse. This has the advantage that the distribution boxes 10 can be fitted in a low-dust, dry environment which is well equipped for that purpose. This also makes it possible to check each connecting point and each distribution box 10 before the cable 1 is delivered to the grower. All this makes the installation of a glasshouse lighting system in a horticultural glasshouse easier.

A feeder cable 20 is fixed to the cover 13 of the distribution box 10, which feeder cable takes off the power current from the cable 1 and supplies it to an individual glasshouse lighting fixture. A connector can be fitted on the end of the feeder cable 20 facing away from the distribution box, for electrical connection of the glasshouse lighting fixture to the power current.

The feeder cable 20 is thinner and considerably more flexible than the glasshouse lighting power current cable 1. This means that the feeder cable 20 no longer exerts any influence on the alignment of the glasshouse lighting fixture relative to the crops to be provided with light. The direction of the light given off by the assimilation lamp in the glasshouse lighting fixture is therefore no longer influenced by the stiffness of the feeder cable 20, which is often in fact the case in known power supply systems.

The distribution box 10 comprises a holder 12 in which a number of contact elements 17 are accommodated. In this example a contact element 17 is the shape of a hollow cylinder with two notches 19 on both ends in the axial direction of the cylinder. The two notches 19 on the one end of the cylinder are intended for the accommodation of a conductor 22a-22c or earth wire 3 of the feeder cable 20, and the two notches 19 on the other end of the cylinder are intended for the accommodation of a conductor 2a-2c or earth wire 3 of the glasshouse lighting power current cable 1.

The width of the notches 19 is preferably selected in such a way that the contact element 17 is wedged on the conductor 2a-22c or earth wire 3, 23 concerned. This ensures a sturdy connection and is easy to fit.

In an alternative embodiment (not shown) the contact elements are provided with a sharp edge or sharp point, so that during the fitting the contact elements penetrate an insulating layer 4 still present round the conductor 2a-2c and/or earth wire 3, at least until there is electrical contact between the contact element and the corresponding conductor 2a-2c or earth wire 3.

The holder 12 with the contact elements 17 is preferably fitted in cover 13 of distribution box 10. Said cover 13 can be placed on the base part 11 of the distribution box 10 and connected to the base part 11, for example by means of lips 15 on the cover 13 which fall into apertures 16 of the base part 11 intended for that purpose.

When cover 13 and base part 11 are connected to each other, the distribution box 10 preferably meets protection class IP 67. This is again in connection with the humid environment prevailing in a horticultural glasshouse and in order to prevent insects or vermin from settling in the distribution box 10. One of the measures which can be taken for this is to fit a nut 14 at the point where the feeder cable 20 leaves the distribution box 10.

It is advantageous if the distribution box 10 is provided with a slanting side 55. In the example of FIG. 3 the slanting side is formed by the edge of upright surface 57.

In an advantageous variant it is possible by means of a phase-determining means to choose for each individual glasshouse lighting fixture the phase with which the fixture concerned is supplied. This phase-determining means can be accommodated in the distribution box 10 belonging to the fixture concerned. As an alternative, the phase-determining means can be fitted between the feeder cable and the fixture, for example in a further connector situated there. The phase-determining means can have a fixed or a variable phase setting. A visual indicator is preferably provided, indicating what phase has been set.

FIG. 4 shows a cross section of a distribution box 10, lying in a rail 25 with a U-shaped cross section. Instead of being U-shaped, the cross section can also be V-shaped, I-shaped or L-shaped. Rail 25 can be fitted in a horticultural glasshouse. The rail 25 with a U-shaped cross section can also be used in cases where the open side of the rail 25 is facing sideways. It is possible for glasshouse lighting fixtures to be suspended from the same rail.

A glasshouse lighting power current cable 1 according to the invention is laid in the rail 25. FIG. 4 shows that a distribution box 10 is resting upon the inside of the rail 25. In this way the rail 25 supports the cable 1, so that the cable 1 does not sag. This is advantageous for the life of the cable 1.

In the embodiment shown in FIG. 4 the cover 13 of the distribution box is formed in such a way that it can be snapped onto the rail 25.

In an alternative embodiment a provision is made on the distribution box 10 enabling the latter to be clamped onto the supporting rail 25. This provision can be, for example, clamp 21, as shown in FIG. 3. The rail 25 does not have to have a U-shaped cross section in that case. The rail 25 in that case can also have, for example, a rectangular or I-shaped cross section.

FIG. 5 shows an alternative embodiment of the system for supplying electrical energy to assimilation lamps in a glasshouse according to the invention. FIG. 7 shows this exemplary embodiment according to FIG. 5 again, but this time in perspective.

In this example the distribution box 10 (which distribution box has a cover 13 and a base part 11) is fixed on rail 100 by means of fixing means 101. The person skilled in the art will understand that the fixing means can be provided in all kinds of different ways. A clamp, clip or snap connection is easy to fit, but a screw connection or a bolt and nut connection are also possible.

In this example a U-shaped rail with support surfaces 102 on the top side is used. In this exemplary embodiment the distribution boxes of the glasshouse lighting power current cable rest on these support surfaces. The cable parts between the successive distribution boxes fall into the space 104 and are consequently protected to some extent from environmental influences. In that way there is also less chance of the cable being pulled loose by persons or vehicles moving about in the glasshouse. A cable part between two successive distribution boxes can rest fully or partially on the bottom surface 103 of the rail, but this is not essential. An advantage of the cable parts concerned resting at least partially on bottom surface 103 is that the cable does not have to bear, or fully bear, its own weight. This reduces the mechanical load on the cable.

Distribution box 10 is also provided with a slanting surface 55 in the exemplary embodiment of FIG. 5.

According to the invention, the rails 25, 100 are fitted during the installation of a system for supplying electrical energy to assimilation lamps in a glasshouse. The rails 25, 100 are preferably fixed to the trellis of the roof of the glasshouse in which the system is being installed.

A suitable prefabricated glasshouse lighting power current cable is rolled out and made to size. The cable is then laid on or in one of the ends of the rail, after which the front end of the cable is seized and taken to the other end of the rail. The cable is pulled along or through the rail in this way. The slanting surface 55 of the distribution boxes 10 of the cable 1 faces in this direction of pulling T. If the housings encounter obstacles, such as, for example, the trusses of the glasshouse, during the pulling of the cable, the slanting surface 55 ensures that the distribution boxes 10 do not become jammed, but slide past the obstacle. The slanting surface 55 is in a position substantially perpendicular to the longitudinal direction of the conductors of the cable, as can be seen in FIGS. 5 and 7.

The distribution boxes 10 are preferably fitted before the cable is pulled over, along or through the rail. If desired, the distribution boxes 10 are fixed on the rail 25, 100.

If a great length of cable is pulled over, along or through the rail, it is advantageous for a cable with hard core and having solid conductors to be used. Such a cable can absorb a greater tensile force than a cable with a soft core. A flat cable is preferably used.

If the cable is fitted on, to or in the rail, an assimilation lamp can be connected to each connecting point. In general, this will be performed by making an electrical connection with a fixture, which fixture is suitable for accommodating an assimilation lamp.

1. System for supplying electrical energy to assimilation lamps in a glasshouse, which system comprises:
at least one glasshouse lighting power current cable for supplying electrical energy to assimilation lamps in a glasshouse, which cable comprises at least three electrically insulated through conductors embedded in the cable for the transmission of three-phase current, the cable being provided with a plurality of prepared connecting points distributed along its length, which connecting points can each be provided with a distribution box, the connecting points in each case being situated at a fixed distance from each other,
a rail which can be fitted in a glasshouse for supporting the glasshouse lighting power supply cable,
one or more distribution boxes, each distribution box comprising one or more contact elements for making an electrical connection between one of the conductors of the glasshouse lighting power current cable and a conductor of a feeder cable for supplying electrical energy to an assimilation lamp in a glasshouse.

2. System according to claim 1, in which the distribution boxes of the glasshouse lighting power current cable can be snapped onto the rail.

3. System according to claim 1, in which a distribution box is connected to a feeder cable for making an electrical connection between the glasshouse lighting power current cable and an assimilation lamp.

4. System according to claim 1, in which the rail has a substantially U-shaped cross section, the open side of the rail facing upwards or sideways after it has been fitted in the glasshouse.

5. System according to claim 1 further comprising a phase-determining means.

6. Glasshouse provided with a system according to claim 1.

7. Method for fitting a system according to claim 1 in a glasshouse, which method comprises:
fixing the rail in a glasshouse,
rolling out a prefabricated glasshouse lighting power current cable,
fixing the glasshouse lighting power current cable in, to or on the rail,
fixing a distribution box on a connecting point of the glasshouse lighting power supply cable, and
electrically connecting a glasshouse lighting fixture to the glasshouse lighting power supply cable, the glasshouse lighting fixture being designed to accommodate an assimilation lamp.

8. Method according to claim 7, in which the glasshouse lighting power current cable is fixed in, to or on the rail in such a way that the rail supports the glasshouse lighting power current cable substantially along its entire length.

9. Glasshouse lighting power current cable for supplying electrical energy to assimilation lamps in a glasshouse, which cable has at least three electrically insulated through conductors embedded in the cable for the transmission of three-phase current, the cable being provided with a plurality of connecting points distributed along its length, each of which connecting points can be provided with a distribution box, which distribution box comprises one or more contact elements for making an electrical connection between one of the conductors of the glasshouse lighting power current cable and a conductor of a feeder cable for supplying electrical energy to an assimilation lamp in a glasshouse, the connecting points in each case being at a fixed predetermined distance from each other, and at least one distribution box on at least one side which is in a position substantially perpendicular to the longitudinal direction of the conductors of the cable having a slanting surface.

10. Glasshouse lighting power current cable according to claim 9, in which the conductors are exposed at the position of a connecting point.

11. Glasshouse lighting power current cable according to claim 10, in which the distribution box comprises spacers for electrically insulating the exposed parts of the conductors relative to each other.

12. Glasshouse lighting power current cable according to claim 9, in which the contact elements and the conductors can be electrically connected by means of clamping.

13. Glasshouse lighting power current cable according to claim 9, in which at least at the position of a connecting point the conductors are situated next to each other in one plane.

14. Glasshouse lighting power current cable according to claim 9, in which the conductors of the cable together can conduct power of at least 10 kW.

15. Glasshouse lighting power current cable according to claim 9, in which the cable also comprises an earth wire.

16. Glasshouse lighting power current cable according to claim 9, in which the cable comprises a plurality of strands, each strand comprising at least three conductors for transmitting three-phase current, and each of the conductors of a strand being for connection to a feeder cable for supplying electrical energy to an assimilation lamp in a glasshouse.

17. Glasshouse lighting power current cable according to claim 16, in which each strand comprises an earth wire in addition to the three conductors for transmitting three-phase current.

18. Glasshouse lighting power current cable according to claim 9, in which the glasshouse lighting power current cable has a hard core.

19. Glasshouse lighting power current cable according to claim 9, in which the glasshouse lighting power current cable comprises one or more solid conductors.
